(19) United States
(12) Patent Application Publication
(10) Pub. No.: US 2006/0042694 A1
(43) Pub. Date: Mar. 2, 2006

(54) Water meter lock

(76) Inventor: Charles Reineck, Las Vegas, NV (US)

Correspondence Address: Morishita Law Firm, L.L.C., Suite 850, 3800 Howard Hughes Pkwy, Las Vegas, NV, 89109, US

(21) Appl. No.: 11/216,597

(22) Filed: Aug. 30, 2005

Related U.S. Application Data
(60) Provisional application No. 60/606,296, filed on Aug. 31, 2004.

(51) Int. Cl. F16K 35/06

(52) U.S. Cl. 137/377

(57) ABSTRACT

A water meter lock for a water meter having a water meter valve mounted on a water meter pipe includes a body, defined by a body wall, and a lock assembly. The body wall forms a substantial enclosure with an opening and is shaped to fit over the water meter valve and fit over at least a portion of the water meter pipe at the opening. The lock assembly is releaseably engaged to the body such that when the body is mounted to the water meter and the lock assembly is engaged to, and cooperates with, the body to surround the water meter pipe, the body substantially encloses the water meter valve to secure the body to the water meter. The lock assembly may take the form of a pin, plate, grate, bar, or the like.

### RELATED APPLICATION DATA

The present application claims the priority of U.S. Provisional Application Ser. No. 60/606,296, entitled “Water Meter Lock,” filed Aug. 31, 2004 by Applicant herein.

### FIELD OF THE INVENTION

The present invention relates to a lock for a water meter, such as that which may be attached to a fire hydrant. Specifically, the present invention is a locking mechanism to prevent unauthorized access to, and use of, the water supply controlled by a water meter.

### BACKGROUND OF THE INVENTION

One common way of providing water to locations where no other means of supply is feasible is by accessing the water supply accessible through fire hydrants. A prime example of such use is for locations such as construction sites, where the municipal water delivery systems have yet to be installed, but where the fire hydrants are already in place. In such cases, it is common for the building contractor to purchase water from the municipality and to obtain that water from the supply which is accessible through an on-site fire hydrant. The purchaser is charged based on usage, and the usage is measured by means of a water meter through which all water obtained must flow (in some locales this meter may be referred to as a “Jones valve”) which is coupled to the fire hydrant for controlling and tracking the volume of water. The builder's water trucks or other water transport devices simply connect to the water meter, open a single valve, and fill up. The meter tracks the water consumed and the builder is charged accordingly.

However, meters so installed do not provide security against unauthorized access, i.e. water theft. They are not lockable, and nothing prevents one builder's water trucks from filling up at the water meter charged to another builder. It has been reported that some builders specifically instruct their water trucks to find an available water meter, one which will not be charged to the builder, and get their water therefrom. There is currently no easy way to restrict the water usage to one's own trucks.

Some users of water meters have attempted to prevent water pilfering with ad hoc methods which have proven generally ineffective. Some have simply tried to lock down the water valve with something like a bicycle chain. This has not worked for two reasons. First, water pilferers can easily damage the valve in attempting to force it open, and the damage to the valve may be more expensive than the cost of the water saved. Second, even with the chain in place, the valve can still be opened somewhat, so pilferage will still go on, albeit more slowly.

Other users have tried removing the valve wheel (or lever, or whatever device is used to open or close the valve). However, many of the pilferers are also users of water meters in their own right, and so have a wheel which can be attached, and even those who do not can simply use a wrench.

Thus, while users have recognized the need in the art for a locking device to protect their water supply, and have attempted creative solutions, such solutions have proven unsuccessful. Thus, there remains a need for a device to prevent unauthorized users from using the water meters charged to others, and pilfering water.

### SUMMARY OF THE INVENTION

The present invention is a water meter lock for a water meter having a water meter valve mounted on a water meter pipe. The water meter lock includes a hollow body defined by a body wall. The body wall forming a substantial enclosure with an opening. The body wall is shaped to fit over the water meter valve at the opening. Optionally, the body wall includes recesses so that the body wall fits over or straddles at least a portion of the water meter pipe.

A lock assembly is releaseably engaged to the body such that when the body is mounted to the water meter and the lock assembly is engaged, the lock assembly secures the body to the water meter. In one optional embodiment, the lock assembly secures the body to the water meter by the cooperation of the body and lock assembly to substantially enclose the water meter valve. Optionally, the lock assembly takes the form of a locking pin removably fitting into one or more holes in the body to obstruct the opening when the water meter lock is mounted. In another optional embodiment, the lock assembly takes the form of a plate hinged to the body to obstruct the opening when the water meter lock is mounted. Optionally, the lock assembly includes a lock to secure the water meter lock to the water meter.

In yet a further optional embodiment, the water meter lock includes an access opening through the body wall. In such an optional embodiment, the access opening is releaseably covered by an access panel. Optionally, the access panel is secured to the body through an access panel lock.

### BRIEF DESCRIPTION OF THE DRAWINGS

FIG. 1 is an elevated front view of a water meter attached to a water source;

FIG. 2 is an elevated side view of a water meter lock according to an embodiment of the present invention;

FIG. 3 is a side view of a lock assembly according to the embodiment of FIG. 2;

FIG. 4 is a side view of a water meter lock according to an embodiment of the present invention mounted on a water meter;

FIG. 5 is a front view of a water meter lock according to the embodiment of FIG. 4 mounted on a water meter;

FIG. 6 is an elevated side view of a water meter lock according to an embodiment of the present invention;

### DESCRIPTION

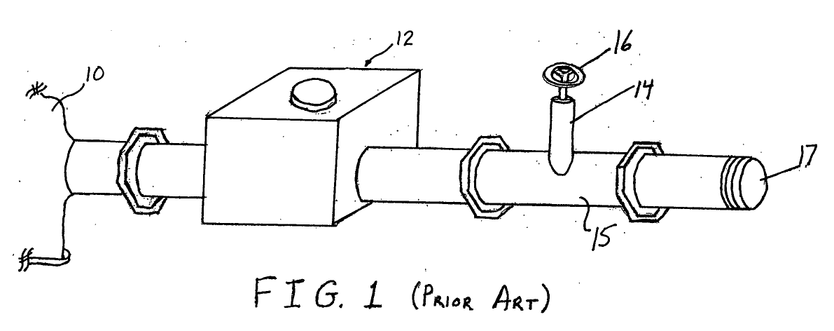

Reference is now made to the figures wherein like parts are referred to by like numerals throughout. Referring first to FIG. 1, a water meter 12 (also known as a “Jones valve”) is illustrated. The water meter 12 attaches to a water source 10, such as a fire hydrant, and permits one to leave the water source 10 unregulated at the water source 10, and use the valve 14 (controlled through a valve handle 16, typically in the form of a wheel or lever) on the water meter 12 to control the flow of water to an outlet 17. In use, water would be delivered to a water truck, water tank, or other destination through the outlet 17. The water from the water source 10 passes through a water meter pipe 15 and the water meter 12 measures the water consumed through that water meter 12.

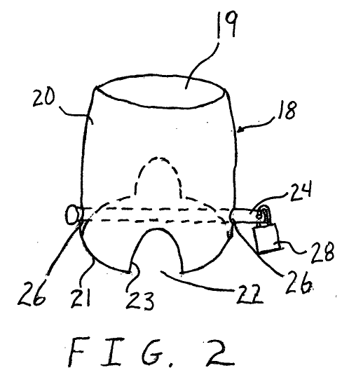

Turning to FIG. 2, the present invention is a water meter lock 18 that includes a hollow body 20 defined by a body wall 21. The body 20 forms a substantial enclosure with an opening 22. In the optional embodiment of FIG. 2, the opening 22 is at one end of the body 20 and a cover 19 encloses the other end of the body 20. The body 20 is sized and shaped to enclose the water meter valve 14. While the optional embodiment of the body 20 shown in the figures is generally cylindrical, it is contemplated that the body 20 could take any shape.

Optionally, the body wall 21 is contoured to fit over the water meter pipe 15. For example, in one optional embodiment, the body wall 21 includes recesses 23 shaped to fit over the water meter pipe 15 while simultaneously enclosing the water meter valve 16. The body wall 21 could be manufactured of any material, including metal or polymer.

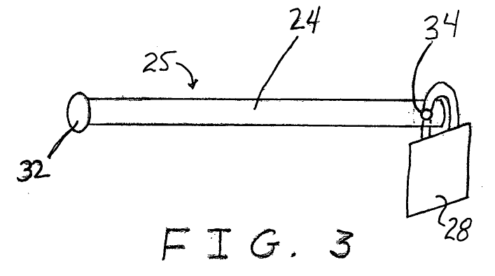

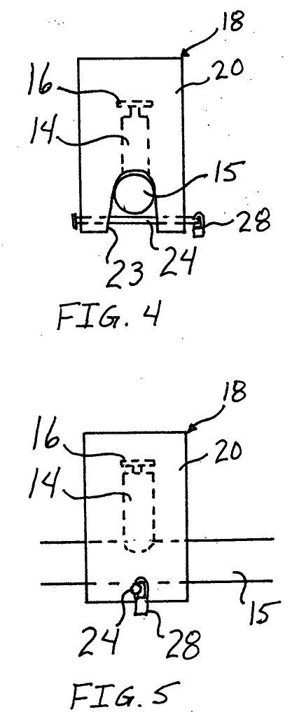

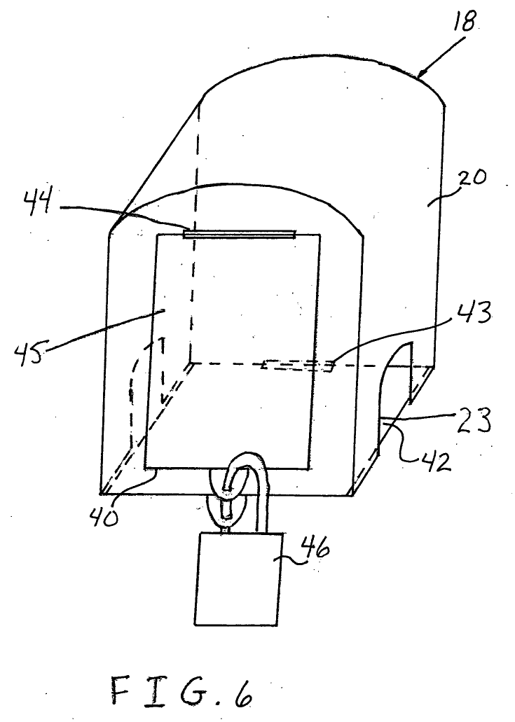

The body 20 is secured to the water meter 12 by a lock assembly 25. In the optional embodiment shown, the lock assembly 25 cooperates with the body 20 to restrict movement and removal of the water meter lock 18 from the water meter 12. The lock assembly 25 could take many different forms. For example, in one optional embodiment, the lock assembly 25 includes a removable locking pin 24, illustrated in FIG. 3. The locking pin 24 of FIG. 3 is inserted through aligned holes 26 located proximate the opening 22 of the water meter lock 18. As shown in FIGS. 4 and 5, when the water meter lock 18 is mounted to the water meter 12, and the locking pin 24 is inserted through the aligned holes 26, the body 20 cooperates with the locking assembly 25 to surround the water meter pipe 25 and secure the water meter lock 18 to the water meter 12. The locking pin 24 may include a stop 32 at one end of the locking pin 24 and a lock 28 to secure the locking pin 24 from removal from the body 20. Optionally, a lock 28 may take the form of a padlock, combination lock, or other lock device inserted through a hole 34 in a locking pin 24.

In another optional embodiment of the lock assembly 25, the locking assembly 25 may be attached to, i.e. non-removable from, the body 20. For example, FIG. 6 illustrates an optional embodiment of the lock assembly 25 includes a plate 42 connected to the body 20 through a hinge 43. While the lock assembly 25 in FIG. 6 includes a continuous plate 42, it is contemplated that the lock assembly 25 in other optional embodiments could include a bar, grate, pin, or other shape to hold the body 20 to the water meter 12.

Referring generally to FIGS. 4 and 5, in use, the lock assembly 25 is placed in an unlocked configuration and the body 20 is mounted to the water meter 12. As noted above, in an optional embodiment, the body 20 is positioned over the water meter valve 14 and straddles the water meter pipe 15. The lock assembly 25 is placed in a locked configuration in which the body is secured to the water meter 12 to prevent access to the water meter valve 14. As noted above, in an optional embodiment, the lock assembly 25 cooperates with the body 20 to surround the water meter 12 and is secured using a lock 28 or the like.

With reference to FIG. 6, the body 20 may optionally include an access opening 40 through which the water meter valve 14 may be accessed without the need to remove the entire water meter lock 18. In such an optional embodiment, an access panel 45 could be secured over the access opening 40 using an access panel lock 46 to selectively restrict access to the water meter valve 14. According to the optional embodiment illustrated, an access panel 45 said would be connected to the body 20 of the water meter lock 18 through a hinge 44. When the access panel lock 46 is released, the access panel 45 could be swung open. It is noted that while the optional embodiment illustrated includes a common lock 46 for both the access panel 45 and the lock assembly 25, it is noted that the plate 42 and access panel 45 could be separately locked. It is also noted that while the access panel 45 of the optional embodiment illustrated is separate from the lock assembly 25 securing the water meter lock 18 to the water meter 12, it is contemplated that in an optional embodiment, the access panel 45 and lock assembly 25 may include a common hinge.

In yet another optional embodiment, the water meter lock 12 may further include a locking cap (not shown) which engages the water meter 12 at the outlet 17. It is noted that the locking cap may be connected to, or separate from, the body 22.

While certain embodiments of the present invention have been shown and described it is to be understood that the present invention is subject to many modifications and changes without departing from the spirit and scope of the claims presented herein.

I claim:

1. A water meter lock for a water meter having a water meter valve mounted on a water meter pipe, comprising:
a hollow body defined by a body wall, said body wall forming a substantial enclosure with an opening, said body wall shaped to fit over said water meter valve at said opening; and
a lock assembly releaseably engaged to said body such that when said body is mounted to said water meter and said lock assembly is engaged, said body substantially encloses said water meter valve and said lock assembly secures said body to said water meter.

2. The water meter lock of claim 1 wherein said body includes at least one hole therethrough proximate said opening and said lock assembly includes a locking pin inserted through said hole such that when said locking pin is inserted through said hole when said body is mounted onto said water meter, said locking pin obstructs said opening to secure said body to said water meter.

3. The water meter lock of claim 1 wherein said lock assembly includes a plate hinged to said body proximate said opening, said plate movable between an open position, in which said opening is not obstructed, and a closed position, in which said opening is obstructed, such that when said body is mounted onto said water meter and said plate is hinged to said closed position, said plate secures said body to said water meter.

4. The water meter lock of claim 1 wherein said body further comprises:
an access opening through said body wall; and
an access panel releasably covering said access opening.

5. A water meter lock for a water meter having a water meter valve mounted on a water meter pipe, comprising:
a hollow body defined by a body wall, said body wall forming a substantial enclosure with an opening, said body wall shaped to fit over said water meter valve and fit over at least a portion of said water meter pipe at said opening; and
a lock assembly releaseably engaged to said body such that when said body is mounted to said water meter and said lock assembly is engaged, said body substantially encloses said water meter valve and said lock assembly secures said body to said water meter.

6. The water meter lock of claim 5 wherein said body includes two aligned holes therethrough proximate said opening and said lock assembly comprises:
a locking pin inserted through said holes such that when said locking pin is inserted through said holes when said body is mounted onto said water meter, said locking pin obstructs said opening to secure said body to said water meter; and
a lock securing said locking pin in said holes.

7. The water meter lock of claim 5 wherein said lock assembly comprises:
a plate hinged to said body proximate said opening, said plate movable between an open position, in which said opening is not obstructed, and a closed position, in which said opening is obstructed, such that when said body is mounted onto said water meter and said plate is hinged to said closed position, said plate secures said body to said water meter; and
a lock securing said plate in said closed position.

8. The water meter lock of claim 5 wherein said body further comprises:
an access opening through said body wall;
an access panel releasably covering said access opening; and
an access panel lock securing said access panel over said access opening.

9. A water meter lock for a water, meter having a water meter valve mounted on a water meter pipe, comprising:
a hollow body defined by a body wall, said body wall forming a substantial enclosure with an opening, said body wall shaped to fit over said water meter valve and fit over at least a portion of said water meter pipe at said opening; and
a lock assembly releaseably engaged to said body such that when said body is mounted to said water meter and said lock assembly is engaged to, and cooperates with, said body to surround said water meter pipe, said body substantially encloses said water meter valve and said lock assembly secures said body to said water meter.

10. The water meter lock of claim 9 wherein said body includes two aligned holes therethrough proximate said opening and said lock assembly comprises:
a locking pin inserted through said holes such that when said locking pin is inserted through said holes when said body is mounted onto said water meter, said locking pin obstructs said opening to secure said body to said water meter; and
a lock securing said locking pin in said holes.

11. The water meter lock of claim 9 wherein said lock assembly comprises:
a plate hinged to said body proximate said opening, said plate movable between an open position, in which said opening is not obstructed, and a closed position, in which said opening is obstructed, such that when said body is mounted onto said water meter and said plate is hinged to said closed position, said plate secures said body to said water meter; and
a lock securing said plate in said closed position.

12. The water meter lock of claim 9 wherein said body further comprises:
an access opening through said body wall;
an access panel releasably covering said access opening; and
an access panel lock securing said access panel over said access opening.
